(19) United States
(12) Patent Application Publication
(10) Pub. No.: US 2010/0172332 A1
(43) Pub. Date: Jul. 8, 2010

(54) Method and apparatus for controlling a vocoder mode in a packet switched voice wirelss network

(76) Inventor: Anil M. Rao, Wheaton, IL (US)

Correspondence Address: Alcatel-Lucent USA Inc.;Docket Administrator, Room 2F-192, 600-700 Mountain Avenue, Murray Hill, NJ, 07974-0636, US

(21) Appl. No.: 12/319,400

(22) Filed: Jan. 7, 2009

(51) Int. Cl. H04W 4/00; G06F 19/00

(52) U.S. Cl. 370/338; 704/201; 704/E19.001

(57) ABSTRACT

A method for controlling speech vocoder rates in a packet switched voice wireless network, comprises a base station included in the network controlling the adaptive multirate (AMR) codec rate. The network may be in accordance with LTE standards and the base station be an eNB.

### FIELD OF THE INVENTION

The present invention relates to a method for controlling a vocoder mode in a packet switched voice wireless network, and more particularly, but not exclusively, to controlling a vocoder mode for Voice over IP in 3GPP LTE.

### BACKGROUND

Currently, the 3rd Generation Partnership Project (3GPP) is developing Long Term Evolution (LTE), also referred to as E-UTRAN, as set out in the technical specification 3GPP TS 36.300 v 8.5.0 (2008-05), to which the reader is referred for additional information, and related documents. 3GPP LTE aims to enhance the Universal Mobile Telecommunications System (UMTS) Radio Access Network standard, for example, by improving efficiency and services.

As the 3GPP evolves UMTS to a pure packet switched technology in 3GPP Long Term Evolution (LTE), voice traffic will be carried in the form of Voice over IP (VoIP). One of the fundamental differences between traditional circuit switched (CS) voice in UMTS and VoIP in LTE is that the radio access network (RAN) no longer has control over adjusting the vocoder rate used by the VoIP application to optimize the trade-off between voice quality and air interface capacity.

Referring to FIG. 1, with conventional CS voice in UMTS, shown on the left hand side of the FIG. 1, voice traffic comes first into the core network through a Mobile Switching Center (MSC) 1, where it is transcoded into the adaptive multirate (AMR) codec. The AMR codec allows different rates to be used to encode the speech (such as 12.2 kbps, 7.95 kbps, 5.9 kbps, etc.) which allows a direct trade-off between the number of bits used to convey the speech and the perceived quality of the speech. A Radio Network Controller (RNC) 2 is able to receive loading measurements from a base station (called the Node-B in UMTS) 3 and, depending on the load, may send a request to the MSC 1 to change the AMR rate used for the downlink transmission to the user equipment (UE) 4. In this way, when the Node-B 3 is lightly loaded in the downlink, the RNC 2 may request that all voice traffic be given the highest AMR codec rate (for example, 12.2 kbps). When the loading increases due to increased call volume, as determined by reports from the Node-B 3, to ensure new users do not get blocked, the RNC 2 can request the MSC 1 to change the AMR rate to a lower rate (for example, 5.9 kbps), which allows a larger number of voice calls to be supported, albeit with lower voice quality. A similar procedure can be used based on the uplink loading reports from the Node-B 3 to the RNC 2, whereby the RNC 2 can send a message to the UE 4 so that the AMR codec rate used by the UE 4 is switched to a lower or higher rate. The ability to adjust the AMR rate based on direct loading measurements from the Node-B 3 is a fundamental advantage of using the AMR codec, and allows the very desirable flexibility of optimizing voice capacity against voice quality.

With 3GPP LTE, the goal was to move to a pure packet switched (PS) technology, so that both voice and data traffic could be transported in a similar way, and there would no longer be the need to maintain two separate domains, that is, circuit switched and packet switched. In addition, in LTE the functions of the RNC entity and Node-B entity in UMTS are collapsed into a single entity called the enhanced Node-B (eNode-B or eNB.)

In LTE, voice is delivered using VoIP, as illustrated on the right hand side of FIG. 1. In VoIP, speech frames are encapsulated into internet protocol (IP) packets in the same way as data traffic (i.e. FTP, HTTP, etc.). The eNode-B in LTE only needs to be aware of the desired quality of service (QoS) attributes of a particular traffic flow, for example, the error rate and delay requirements; it does not strictly need to know that it is carrying in particular voice traffic using the AMR codec. Another fundamental change is that the AMR codec used for downlink transmission is not directly accessible by the eNode-B, as it may be residing in the operator's IP Multimedia Subsystem (IMS) if the operator chooses to use IMS, or it may be located in a media gateway (MGW) somewhere in the operator's network, or it may even be located directly in another UE which placed the call. Thus, the eNode-B is not able to request changes in the AMR codec rate in the same way as was possible in UMTS to trade off air interface capacity against speech quality.

### BRIEF SUMMARY

According to a first aspect of the invention, a method for controlling a vocoder mode in a packet switched voice wireless network that includes at least one base station, comprises: the base station controlling the adaptive multirate (AMR) codec mode of the vocoder. The method may be applied to networks in accordance with LTE standards, in which the base station is an eNB. However, it may be applicable to networks implemented in accordance with other technologies and/or standards where packet switched speech is involved.

In a method in accordance with the invention, the base station measures loading conditions and controls the codec mode depending on the measured conditions.

In another method in accordance with the invention the base station modifies a Codec Mode Request (CMR) field of a speech packet to control the codec mode. The base station may modify the CMR field of a speech packet received by the base station in the uplink from a user equipment (UE) so as to control the codec mode for speech packets being sent to the UE in the downlink. The base station may modify the CMR field of a speech packet sent by the base station in the downlink to a user equipment (UE) so as to control the codec mode for speech packets being sent from the UE in the uplink. The base station may compute the checksum in the UDP header after it has modified the CMR field using the modified CMR field in the computation.

In another method in accordance with the invention, the base station sends control messages to the UE to control the codec mode. Where the network is implemented in accordance with LTE, the control messages may be Radio Resource Control (RRC) messages. To modify the codec mode in the downlink, the base station may send a control message to the UE requesting the UE to modify a CMR field in a speech packet being sent in the uplink. To modify the codec in the uplink, the base station may send a control message to the UE requesting the UE to change the codec mode the UE is using.

According to a second aspect of the invention, a base station is operative to use a method in accordance with the first aspect.

According to a third aspect of the invention a wireless network is arranged to use a method in accordance with the first aspect.

### BRIEF DESCRIPTION OF THE DRAWINGS

Some embodiments of the present invention will now be described by way of example only, and with reference to the accompanying drawings, in which:

FIG. 1 schematically illustrates the implementation of circuit switched voice in UMTS compared to VoIP in LTE;

FIG. 2 schematically illustrates the structure of a VoIP packet for LTE;

FIG. 3 schematically illustrates a protocol stack for VoIP in LTE in the downlink direction;

FIG. 4 schematically illustrates a protocol stack for VoIP in LTE in the uplink direction;

FIG. 5 schematically illustrates a method in accordance with the invention;

FIG. 6 schematically illustrates a method in accordance with the invention; and

FIG. 7 schematically illustrates part of an LTE network and eNode-B in accordance with the invention.

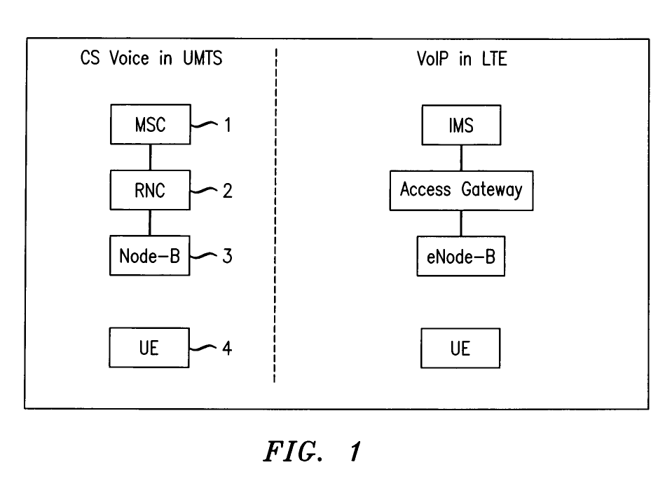

### DETAILED DESCRIPTION

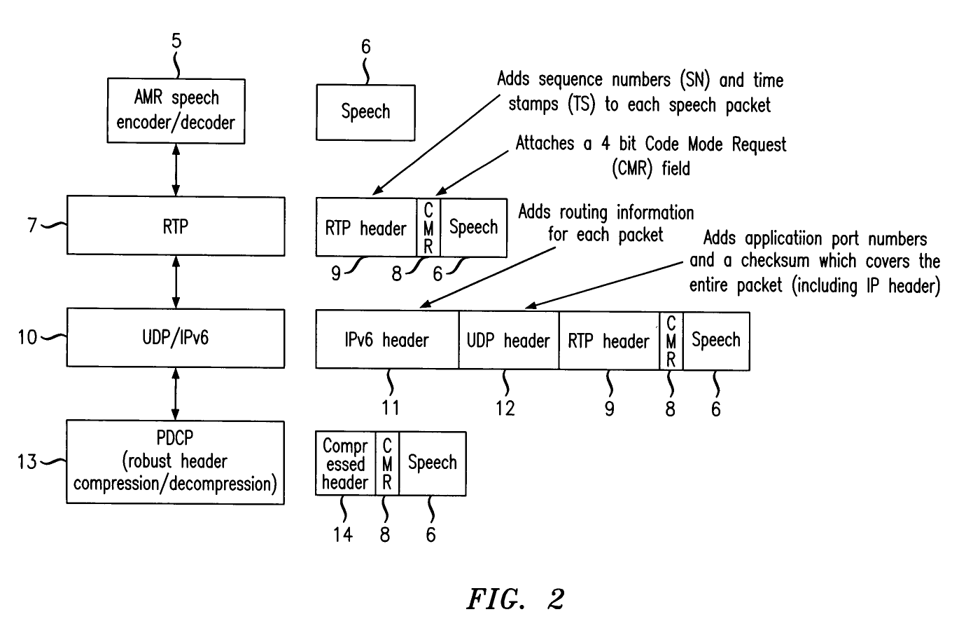

FIG. 2 illustrates the structure of a VoIP packet for LTE. An AMR speech encoder 5 produces a speech frame 6 every 20 ms and the number of bits in the packet depends 7 on the AMR codec rate chosen. The Real-time Transport Protocol (RTP) layer then appends a Codec Mode Request (CMR) field 8, which is 4 bits in length, and also adds an RTP header 9. The RTP header 9 supplies a time stamp and sequence number which will be used by the receiving RTP entity to properly play out the speech frames. The purpose of the CMR field 8 is to allow the AMR decoder on the receiving end of the link to request that the AMR codec mode used by the transmitting side of the link be changed. The UDP/IP layer 10 adds another set of headers. The IP header 11 provides routing information so that the speech packet reaches the proper destination. The UDP header 12 adds application port numbers as well as a checksum which is computed over the entire packet (including the IP header). This checksum is used at the receiving UDP entity to check if the packet has been corrupted, in which case it would be discarded at the receiving entity.

Next, when the packet enters the LTE protocol stack (either the eNode-B on the downlink or the LTE part of the protocol stack in the UE on the uplink), it enters the Packet Data Convergence Protocol (PDCP) layer 13. In this layer the parts of the RTP/UDP/IP header which can be compressed will be compressed to give a compressed header 14 and improve air interface capacity. The receiving PDCP entity will take care of decompressing the packet. The compression/decompression protocol is known as Robust Header Compression (RoHC).

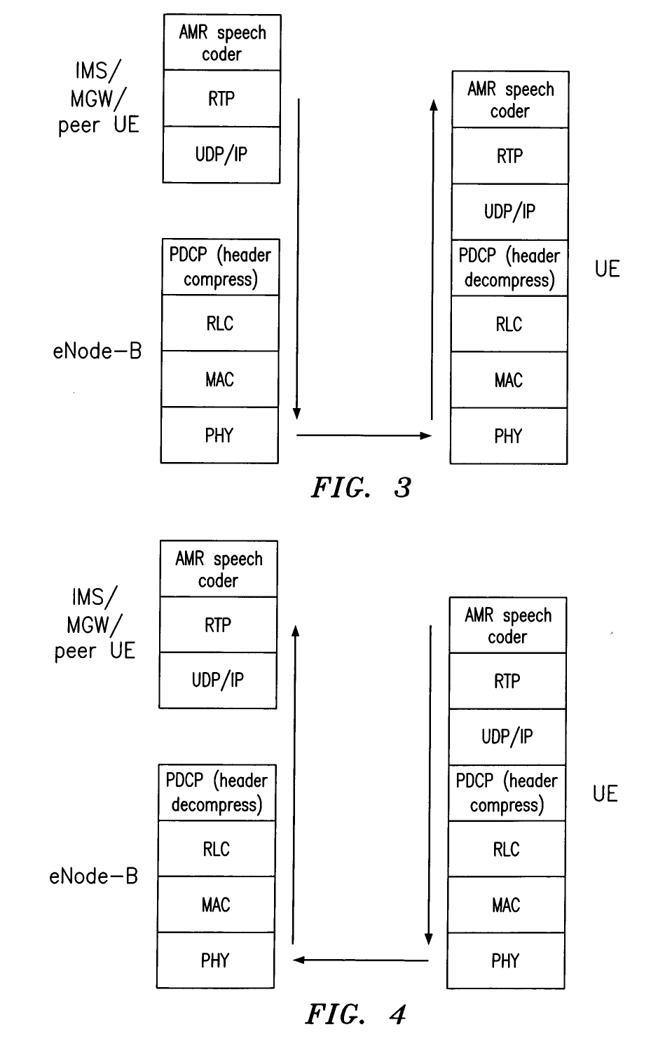

FIGS. 3 and 4 illustrate the protocol stack for delivering VoIP packets in the downlink and uplink, respectively. Note that there is no indication for the AMR speech encoder and the AMR speech decoder for uplink and downlink, because voice is typically a two way session and hence the AMR vocoder typically contains both the encoder and decoder functions.

In one embodiment of the invention, the eNode-B changes the AMR codec mode in a particular link direction (e.g. downlink or uplink), by modifying the CMR field in the VoIP packets sent in the opposite link.

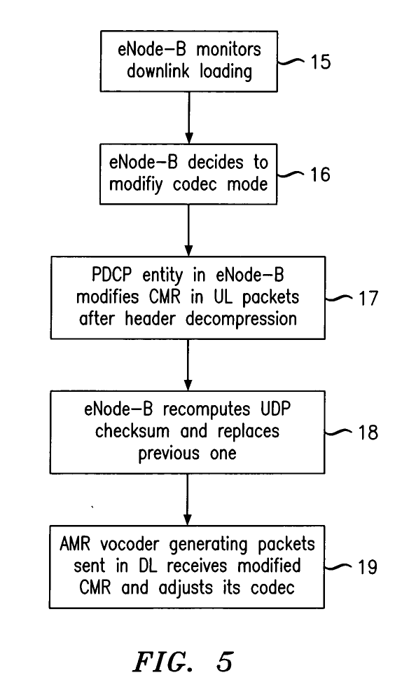

FIG. 5 illustrates modifying the codec mode for VoIP packets being sent in the downlink direction. The eNode-B measures its loading in the downlink at 15. At 16, the eNode-B decides if it is appropriate to modify the AMR codec mode being used for voice traffic delivered to a particular UE in the downlink. In this example, it is assumed that the eNode-B measurements indicate that the downlink loading is becoming high, in the sense that the number of voice calls is currently near capacity limit for the current AMR vocoder rate. Alternatively, the measurements might indicate that no change is required or that loading may be increased.

If at 16, the eNode-B decides to modify the codec mode to reduce downlink loading, at 17 it modifies the CMR field in the VoIP packets being sent in the uplink direction, that is, from the UE to the eNodeB. The modified CMR field will then reach the AMR vocoder used to generate the speech packets being sent in the downlink, and the AMR codec mode will be changed appropriately. The CMR is modified inside the PDCP layer in the eNode-B. This can be carried out either prior to or after header decompression, but in this embodiment it is carried out after header decompression. Modifying the CMR after header decompression is advantageous because the packet size and the location of the CMR field is then known precisely. The CMR field is set to achieve the desired AMR codec rate that will be used in the downlink direction.

The checksum that was computed in the UDP header on the UE transmit side was computed assuming the original value of the CMR field. The UDP checksum is recomputed in the eNode-B at 18 using the modified CMR field. Given that both the CMR field and the UDP checksum will need to be altered by the eNode-B, it is advantageous for this to be carried out in the PDCP entity in the eNode-B. The eNode-B then replaces the old UDP checksum with the newly computed checksum. This ensures that the UDP checksum passes when the packet reaches the UDP/IP layer.

At 19, the AMR vocoder which is generating packets being sent in the downlink receives the modified CMR and will accordingly adjust its AMR codec to a lower rate. The same technique can be used to modify the AMR vocoder rate in the uplink, only the CMR field of the VoIP packets being sent in the downlink direction would be modified.

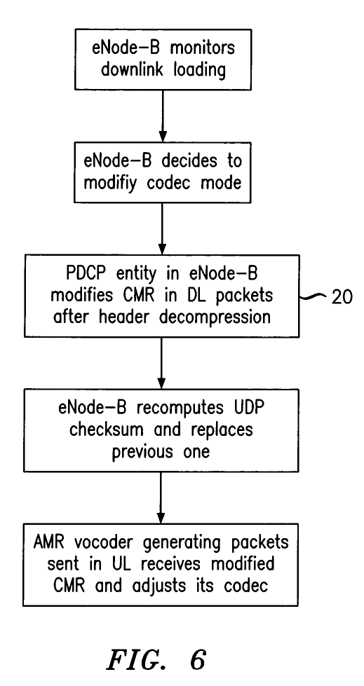

With reference to FIG. 6, the eNode-B may also control the AMR codec mode used in the uplink, by modifying the CMR field of the VoIP packets being sent in the downlink to that UE, as shown at 20.

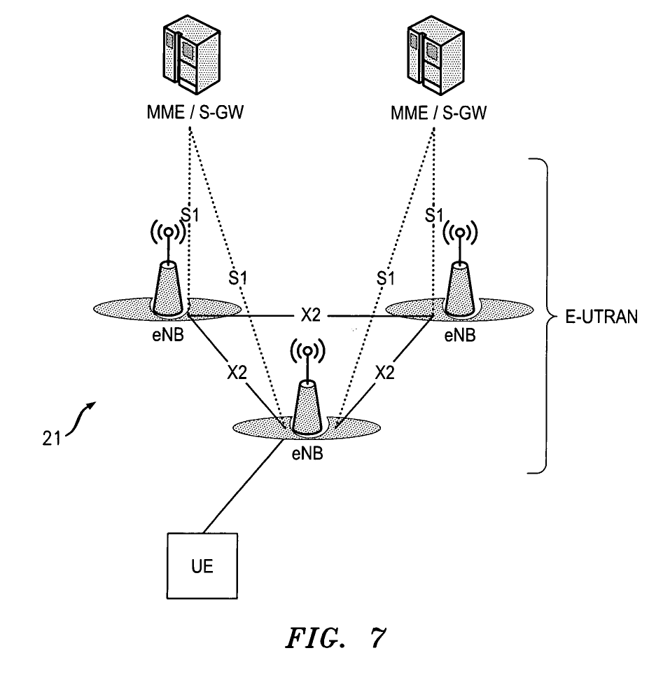

In another embodiment of the invention, specific control messages in the 3GPP LTE standard are sent from the eNode-B to the UE to effect the desired change in the AMR codec. FIG. 7 schematically illustrates part of an LTE network 21 having a plurality of eNode-Bs. Radio Resource Control (RRC) messages, that is, control plane messages are sent between the eNode-B and the UE in the LTE standard.

To control a change of the AMR codec rate in the uplink direction, the eNode-B sends an RRC message to the UE requesting that the UE change the AMR codec that the UE is using.

To control a change of the AMR codec rate in the downlink direction, the eNode-B sends an RRC message to the UE requesting that the UE modify the CMR field in the VoIP packet being sent in the uplink. This then reaches the peer entity that is sending the AMR speech packets in the downlink direction and has the effect of changing the AMR codec rate to the desired rate.

The eNode-Bs of the LTE network may alternatively, or in addition, be implemented in accordance with the embodiment described with reference to and as illustrated in FIGS. 5 and 6.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A method for controlling a vocoder mode in a packet switched voice wireless network that includes at least one base station, comprising: the base station controlling the adaptive multirate (AMR) codec mode of the vocoder.

2. The method as claimed in claim 1 and wherein the network is in accordance with LTE standards and the base station is an eNB.

3. The method as claimed in claim 1 and including the base station measuring loading conditions and controlling the codec mode depending on the measured conditions.

4. The method as claimed in claim 1 and including the base station modifying a Codec Mode Request (CMR) field of an RTP packet having a speech frame payload to control the codec mode.

5. The method as claimed in claim 1 and including the base station modifying a Codec Mode Request (CMR) field of a speech packet to control the codec mode.

6. The method as claimed in claim 5 and including the base station modifying the CMR field of a speech packet received by the base station in the uplink from a user equipment (UE) so as to control the codec mode for speech packets being sent to the UE in the downlink.

7. The method as claimed in claim 5 and including the base station modifying the CMR field of a speech packet sent by the base station in the downlink to a user equipment (UE) so as to control the codec mode for speech packets being sent from the UE in the uplink.

8. The method as claimed in claim 5 and including the base station computing the checksum in the UDP header after it has modified the CMR field using the modified CMR field in the computation.

9. The method as claimed in claim 8 and including the base station carrying out its computation of the checksum, after it has modified the CMR field, in a packet data convergence protocol (PDCP) entity in the base station.

10. The method as claimed in claim 5 and including the base station modifying the CMR field after header decompression.

12. The method as claimed in claim 1 and including the base station sending control messages to the UE to control the codec mode.

13. The method as claimed in claim 12 and wherein the network is in accordance with LTE standards and the base station is an eNB, and the control messages are Radio Resource Control (RRC) messages.

14. The method as claimed in claim 12 and wherein, to modify the codec mode in the downlink, the base station sends a control message to the UE requesting the UE to modify a CMR field in a speech packet being sent in the uplink.

15. The method as claimed in claim 12 and wherein, to modify the codec in the uplink, the base station sends a control message to the UE requesting the UE to change the codec mode the UE is using.

16. A base station for a wireless network comprising a controller for controlling an adaptive multirate (AMR) codec mode of a vocoder for packet switched voice.

17. The base station as claimed in claim 16 and wherein it is an eNode-B.

18. The base station as claimed in claim 16 and including a processor for modifying a Codec Mode Request (CMR) field of an RTP packet having a speech frame payload to control the codec mode.

19. A wireless network comprising a base station for a wireless network comprising a controller for controlling an adaptive multirate (AMR) codec mode of a vocoder for packet switched voice.

20. The wireless network as claimed in claim 19 and wherein it is implemented in accordance with LTE standards.
